(19) United States
(12) Patent Application Publication
(10) Pub. No.: US 2016/0299267 A1
(43) Pub. Date: Oct. 13, 2016

(54) THERMAL RESISTANT TITANIUM DIOXIDE PARTICLES AND THE FORMATION OF COOL ARTICLES

(71) Applicant: THE CHEMOURS COMPANY TT, LLC, HARRISBURG, PA (US)

(72) Inventor: J. DON CONNOLLY, JR., WILMINGTON, DE (US)

(21) Appl. No.: 15/078,125

(22) Filed: Mar. 23, 2016

Related U.S. Application Data
(60) Provisional application No. 62/146,566, filed on Apr. 13, 2015.

(51) Int. Cl. G02B 5/08

(52) U.S. Cl. CPC G02B 5/08

(57) ABSTRACT

The present disclosure relates to titanium dioxide particles designed to enhance reflection of both IR and visible wavelengths, or energy, and their use in forming cool, fully opaque polymeric articles prepared by melt processible resin. Such articles, made from melt processible thermoplastic and/or thermoset resin have enhanced outdoor utility because they inhibit damage caused by the sun as a result of the article including titanium dioxide particles of the present invention exhibiting low photo-activity properties.

### BACKGROUND OF THE DISCLOSURE

1. Field of the Disclosure

The present disclosure relates to titanium dioxide particles designed to enhance reflection of both IR and visible wavelengths, or energy, and their use in forming cool, fully opaque polymeric articles prepared by melt processible resin. Such articles, made from melt processible thermoplastic and/or thermoset resin have enhanced outdoor utility because they inhibit damage caused by the sun as a result of the article including titanium dioxide particles of the present invention exhibiting low photo-activity properties.

2. Description of the Related Art

Numerous commercial applications, including PVC siding/decking, synthetic turf, cool roofing, and automotive interiors, have a well-documented need to reduce or manage heat build-up caused by the absorption of energy from incident solar radiation. As a result, many commercial products have been developed offering increased IR reflectivity as a mechanism for reducing solar heating. One example is described in Japanese Patent Number 4517178 patent teaching a film (a cloth painted with a non-melt processible thermoplastic resin coating) for use in tent structures that is both heat shielding and having a high degree of freedom in regard to illumination colors. This film (or fabric coated with the non-melt processible thermoplastic resin) includes: a) a fiber base cloth, b) a non-melt processible thermoplastic resin coating, and c) an antifouling resin coating layer provided on top of the non-melt processible thermoplastic resin coating. The non-melt thermoplastic resin coating comprises indeterminate inorganic compound particles having a refractive index of 1.8 to 2.75, a particle size distribution of 0.3 to 3.0 um, and an aspect ratio of 1.0 to 3.0. The anti-fouling layer comprising a non-melt processible resin preferably comprises 0.3 to 30 mass % of indeterminate inorganic compound particles with a refractive index of 1.8 or greater, a particle size distribution of 0.3 to 3.0, and an aspect ratio of 1.0 to 3.0. The '178 patent teaches using TiO2 particles having a medium particle size range of 0.070 um (a collection of titanium particles having particle sizes between 0.3 um to 1.0 um). Such TiO2 particles efficiently scatter IR wavelengths but do not efficiently scatter visible wavelengths that make up solar radiation and are unable to achieve maximum heat protection.

Another example of a technology capable of managing heat buildup is described in published unexamined Japanese patent application number H4-258675. The '675 application teaches a new coating that can prevent the accumulation of snow in the winter. This coating (made from non-melt processible resin), comprises a resin selected from a group made up of silicone rubber, acrylic-silicone resins, and fluorine resins. This heat-insulating, snow accumulation-preventing coating contains heat-insulating filler, such as an inorganic filler whose main component is, for example, a collection of titanium oxide particles with diameters in the range of 0.1 to 1.0 um. It also teaches that to keep the activation of the fine-particle titanium oxide in check, the surface of the titanium oxide fine particles may be thinly coated with silicon oxide or alumina and the coating requires from 10 to 300 parts by weight of heat insulating filler. The coating also includes a high-durability water-repellent additive that lowers the coefficient of friction of a paint with respect to accumulated snow, a dispersant, a coatability improvement agent, and a chemical reaction resin that minimizes the surface adhesion coefficient between accumulated snow and the paint.

Typically when referring to the spectral output of solar radiation, wavelengths between 400 and 700 nanometers are referred to as the visible spectrum. Wavelengths below 400 nanometers are the ultraviolet spectrum and wavelengths above 700 nanometers are infrared. The major portion of the suns energy output is in the visible and infrared portions of its spectrum. Additionally, some polymeric articles are sensitive to the ultraviolet portion of the spectrum whereby those wavelengths of light (250-400 nanometers) have the ability to break polymeric chains thereby reducing the mechanical properties of polymeric material.

Consequently, increasing IR reflectivity has been effectively documented to reduce heat buildup but only 52% of incident solar radiation is in the near IR wavelength region and the remaining 43% is in the visible region. Applying both IR and visible light to a surface results in an article getting hot due to heat buildup as energy is absorbed. In addition, sun light may be destructive to some articles made of polymers because the composition of the article results in the resin becoming photo unstable. For example, an article such as siding on a house warms in the sun resulting in the interior of a house getting warm while the sun is damaging the polymer composition of the siding. If the house gets too hot, energy is used to cool the house. For purposes of conserving energy, a mechanism is needed for scattering both IR and visible wavelengths of light within articles while enhancing the photo stability of articles placed in the sun.

### SUMMARY OF THE INVENTION

The present invention results from the surprisingly discovery that TiO2 particles within a narrow particle size range have optimal scattering of both infrared (“IR”) wavelengths and visible wavelengths that enhance the photo stability of articles. Specifically, articles of the present invention are formed by adding TiO2 particles of the present invention to melt processible thermoplastic and/or thermoset polymers that must be heated and then extruded to form articles such as, for example, house siding.

These thermal resistant articles of the present invention have enhanced resistance to infrared and solar radiation thereby helping to keep the surfaces of articles cool when in sunlight by reflecting energy.

Specifically, the thermal resistant, low photo-activity, titanium dioxide particles of the present invention comprise: a) a TiO2 particle comprising a surface having a median particle size between 0.30 um and 0.38 um; b) a silica coating; c) an alumina coating having an interior and exterior surface; and d) an organic coating, wherein the silica coating is located between the surface of the TiO2 particle and the interior surface of the alumina coating and the organic coating is located on the exterior surface of the alumina coating. It is preferred that these TiO2 particle are in a rutile crystalline form. It is preferred that the organic coating is selected from the group of organic compounds selected from the group consisting of an organosiloxane, organosilane, alkyl carboxylic acid, alkyl sulfonate, organophosphate, orgaonophosphonate, and a combination thereof. It is most preferred that the organic coating is polydimethyl siloxane. It is also preferred that the median particle size is in the range of 0.32 and 0.36., and most preferred when the median particle size is in the range of 0.32 um and 0.35 um. It is also preferred that the silica coating is in the range of 1.0 to 5.0 wt. % of the total particle weight.

A second embodiment of the invention are thermal resistant compositions comprising: a) a melt processible resin selected from the group consisting of a thermoplastic resin, a thermoset resin, or a combination thereof; and b) one or more TiO2 particles (described above) comprising i) a surface and having median particle size between 0.30 and 0.38 μ; ii) a silica coating; iii) an alumina coating having an interior and exterior surface; and d) an organic coating, wherein the silica coating is located between the surface of the TiO2 particle and the interior surface of the alumina coating and the organic coating is located on the exterior surface of the alumina coating. The thermal compositions of the present invention may further comprises non-TiO2 inorganic fillers.

### FIGURES

FIG. 1 depicts a chart illustrating temperature rise versus particle size distribution (PSD).

FIG. 2 depicts a chart illustrating spectral comparison versus particle size distribution.

### DETAILED DESCRIPTION OF THE DISCLOSURE

In this disclosure “comprising” is to be interpreted as specifying the presence of the stated features, integers, steps, or components as referred to, but does not preclude the presence or addition of one or more features, integers, steps, or components, or groups thereof. Additionally, the term “comprising” is intended to include examples encompassed by the terms “consisting essentially of” and “consisting of.” Similarly, the term “consisting essentially of” is intended to include examples encompassed by the term “consisting of.”

In this disclosure, when an amount, concentration, or other value or parameter is given as either a range, typical range, or a list of upper typical values and lower typical values, this is to be understood as specifically disclosing all ranges formed from any pair of any upper range limit or typical value and any lower range limit or typical value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

In this disclosure, terms in the singular and the singular forms “a,” “an,” and “the,” for example, includes plural references unless the content clearly dictates otherwise. Thus, for example, reference to “TiO2 particle”, “a TiO2 particle”, or “the TiO2 particle” also includes a plurality of TiO2 particles.

It is contemplated that any inorganic particle may be used in the present invention. By inorganic particle it is meant an inorganic particulate material that becomes uniformly dispersed throughout a polymer melt, and imparts color and opacity to the polymer melt. Some examples of inorganic particles include but are not limited to ZnO, TiO₂, CaCO₃, BaSO₄, silica, talc and/or clay.

In particular, titanium dioxide is the preferred inorganic particle in the processes and products of this disclosure. Titanium dioxide (TiO₂) particles may be in the rutile or anatase crystalline form. It is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference.

By “particle” it is meant that the inorganic particle has a medium size range of 0.35 um, 0.34 um, 0.33 um, or 0.32 um, in other words a collection of inorganic particles having a primary particle size distribution (not the size of aggregates/agglomerates) in the range of 0.30 um to 0.38 um, 0.30 um to 0.32 um, 0.31 um to 0.38 um, of from 0.31um to 0.36 um, from 0.31 um to 0.34 um, from 0.32 um to 0.34 um, from 0.32 um to 0.36 um, from 0.32 um to 0.33 um, from 0.32 um to 0.35 um, as measured by X-Ray centrifuge technique, specifically utilizing a Brookhaven Industries model TF-3005W X-ray Centrifuge Particle Size Analyzer.

The inorganic particles of the present invention may be substantially pure, such as containing only one type of inorganic; for example, titanium dioxide, or may be treated with other metal oxides, such as silica, alumina, and/or zirconia. The inorganic particles may be treated with metal oxides, for example, by co-oxidizing or co-precipitating inorganic compounds with metal compounds. If an inorganic particle is co- oxidized or co-precipitated, then up to about 20 wt. % of the other metal oxide, more typically, 0.5 to 5 wt. %, most typically about 0.5 to about 1.5 wt. % may be present, based on the total particle weight.

Titanium dioxide particles of the rutile or anatase crystalline form possess a well-known characteristic ability to absorb light in the ultraviolet (UV) wavelength range, a process that generates metastable electron poor and electron rich regions within the particle structure. If the surfaces of said particles are not suitably modified, the interaction of water and/or oxygen with said regions results in the generation of highly reactive, oxygen atom-based radical species that can over time degrade the appearance and/or the physical properties of many of the thermoplastic polymer matrices into which the aforementioned particles might be incorporated (see D. Holtzen, P. Niedenzu, M. Diebold, “TiO2 Photochemistry and Color Applications”, Society of Plastics Engineers' 2001 Annual Technical Conference Proceedings) incorporated herein by reference. Put differently, unless suitably modified, the UV light induced photoactivity of titanium dioxide particles for the most part prevents their use for the manufacture of thermoplastic polymer derived articles that require a commercially useful level of photodurability. Common examples of thermoplastic polymer matrices that are typically affected by this problem include, but are not limited to, those based on polyethylene, polypropylene and polyvinyl chloride, resins used in the present invention.

A surface modification technique that effectively mitigate the aforementioned photoactivity involves the encapsulation of said particles in a layer of amorphous silica which is then followed by the deposition of crystalline alumina of boehmite or boehmite-like morphology. An example of such a particle encapsulation process is taught in U.S. Pat. No. 5,993,533, incorporated herein by reference. The amorphous silica portion of this type of particle treatment is typically present at levels that range from about 1 wt % to about 10 wt % (total particle basis) while the crystalline alumina portion of said treatment is typically present at levels that range from about 1 wt % to about 5 wt % (total particle basis).

Another surface modification technique that can be employed to significantly mitigate the undesirable photoactivity of titanium dioxide particles involves encapsulating them in a layer of only amorphous alumina. An example of such a particle encapsulation process is taught in Example 1 of U.S. Pat. No. 4,460,655 incorporated herein by reference. In this process, fluoride ion, typically present at levels that range from about 0.05 wt. % to 2 wt. % (total particle basis), is used to disrupt the crystallinity of the alumina, typically present at levels that range from about 1 wt. % to about 8 wt. % (total particle basis), as the latter is being deposited onto the titanium dioxide particles. Note that other ions that possess an affinity for alumina such as, for example, citrate, phosphate or sulfate can be substituted in comparable amounts, either individually or in combination, for the fluoride ion in this process.

Thermal resistant compositions or articles of the present invention typically include between about 0.1 to about 50 wt. %, or about 0.5 to about 30 wt. %, or about 0.5 to about 10 wt. %, less than 10, or preferably about 10 to 15 wt. % of inorganic particles (based on the total weight of the thermal resistant composition or article).

Inorganic particles used in the present invention may be treated with an organic compound such as low molecular weight polyols, organosiloxanes, organosilanes, alkylcarboxylic acids, alkylsulfonates, organophosphates, organophosphonates and mixtures thereof. The preferred organic compound is selected from the group consisting of low molecular weight polyols, organosiloxanes, organosilanes and organophosphonates and mixtures thereof and the organic compound is present at a loading of between 0.20 wt. % and 2.00 wt. %, 0.30 wt. % and 1.00 wt. %, or 0.70 wt. % and 1.30 wt. % on a total particle basis. One of the preferred organic compounds used in the present invention is polydimethyl siloxane.

When the inorganic particles of the present invention are used in a polymer composition/melt, the melt-processible polymer that can be employed together with the inorganic particles of this disclosure comprises a high molecular weight polymer, preferably thermoplastic resin, thermoset resin, or a combination thereof. By “high molecular weight” it is meant to describe polymers having a melt index value of 0.01 to 50, typically from 2 to 10 as measured by ASTM method D1238-98. By “melt-processable,” it is meant a polymer must be melted (or be in a molten state) before it can be extruded or otherwise converted into shaped articles, including films and objects having from one to three dimensions. Also, it is meant that a polymer can be repeatedly manipulated in a processing step that involves obtaining the polymer in the molten state. Polymers that are suitable for use in this disclosure include, by way of example but not limited thereto, polymers of ethylenically unsaturated monomers including olefins such as polyethylene, polypropylene, polybutylene, and copolymers of ethylene with higher olefins such as alpha olefins containing 4 to 10 carbon atoms or vinyl acetate; vinyls such as polyvinyl chloride, polyvinyl esters such as polyvinyl acetate, polystyrene, acrylic homopolymers and copolymers; phenolics; alkyds; amino resins; epoxy resins, polyamides, polyurethanes; phenoxy resins, polysulfones; polycarbonates; polyesters and chlorinated polyesters; polyethers; acetal resins; polyimides; and polyoxyethylenes. Mixtures of polymers are also contemplated. Polymers suitable for use in the present disclosure also include various rubbers and/or elastomers, either natural or synthetic polymers based on copolymerization, grafting, or physical blending of various diene monomers with the above-mentioned polymers, all as generally known in the art. Typically, the polymer may be selected from the group consisting of polyolefin, polyvinyl chloride, polyamide and polyester, and mixture of these. More typically used polymers are polyolefins. Most typically used polymers are polyolefins selected from the group consisting of polyethylene, polypropylene, and mixture thereof. A typical polyethylene polymer is low density polyethylene and linear low density polyethylene.

A wide variety of additives may be present in a thermal resistant composition produced by the process of this disclosure as necessary, desirable, or conventional. Such additives include polymer processing aids such as fluoropolymers, fluoroelastomers, etc., catalysts, initiators, antioxidants (e.g., hindered phenol such as butylated hydroxytoluene), blowing agent, ultraviolet light stabilizers (e.g., hindered amine light stabilizers or “HALS”), organic pigments including tinctorial pigments, plasticizers, antiblocking agents (e.g. clay, talc, calcium carbonate, silica, silicone oil, and the like) leveling agents, flame retardants, anti-cratering additives, and the like. Additional additives further include plasticizers, optical brighteners, adhesion promoters, stabilizers (e.g., hydrolytic stabilizers, radiation stabilizers, thermal stabilizers, and ultraviolet (UV) light stabilizers), antioxidants, ultraviolet ray absorbers, anti-static agents, colorants, dyes or pigments, delustrants, fillers, fire-retardants, lubricants, reinforcing agents (e.g., glass fiber and flakes), processing aids, anti-slip agents, slip agents (e.g., talc, anti-block agents), and other additives.

Any melt compounding techniques, known to those skilled in the art may be used. Generally, inorganic particle, other additives and melt processable polymer are brought together and then mixed in a blending operation, such as dry blending, that applies shear to the polymer melt to form the particle containing thermal resistant polymer. The melt processable polymer is usually available in the form of particles, granules, pellets or cubes. Methods for dry blending include shaking in a bag or tumbling in a closed container. Other methods include blending using agitators or paddles. Inorganic particles, and melt-processable polymer may be co-fed using screw devices, which mix the treated particle, polymer and melt-processable polymer together before the polymer reaches a molten state. Alternately, the components may be fed separately into equipment where they may be melt blended, using any methods known in the art, including screw feeders, kneaders, high shear mixers, blending mixers, and the like. Typical methods use Banbury mixers, single and twin screw extruders, and hybrid continuous mixers.

Processing temperatures depend on the polymer and the blending method used and are well known to those skilled in the art. The intensity of mixing depends on the polymer characteristics. The treated particle containing polymer composition produced by the process of this disclosure is useful in the production of shaped articles. An article of the present invention can be a stand-alone article or attached to one or more different substrates or an article may contain multiple layers of the same composition. A film of the present invention may have a thickness in the range of 2.0 mils to 300 mils, a thick film or polymeric web, or be a thin film having a thickness in the range of 0.25 mils to 2.0 mils. The composition of the present invention may not be attached to substrate such as cloth or it may be attached to a substrate such as wood, stone, tile, shingles, etc. The composition of the present invention may be free of, or substantially free of, water-repellent additive that lowers the coefficient of friction, a dispersant, a coatability improvement agent, and a chemical reaction resin that minimizes the surface adhesion coefficient between accumulated snow and the paint. The amount of inorganic particle present in the particle-containing polymer composition and shaped polymer article will vary depending on the end use application. However, typically, the amount of particle in the polymer composition ranges from about 30 to about 90 wt. %, based on the total weight of the composition, preferably, about 50 to about 80 wt. %. The amount of particle in an end use, such as a shaped article, for example, a polymer film, can range from about 0.01 to about 20 wt. %, and is preferably from about 0.1 to about 15 wt. %, more preferably 5 to 10 wt. %. A shaped article is typically produced by melt blending the treated particle containing polymer which comprises a first high molecular weight melt-processable polymer, with a second high molecular weight melt-processible polymer to produce the polymer that can be used to form the finished article of manufacture. The treated particle containing polymer composition and second high molecular weight polymer are melt blended, using any means known in the art, as disclosed hereinabove. In this process, twin-screw extruders are commonly used. Co-rotating twin-screw extruders are available from Werner and Pfleiderer. The melt blended polymer is extruded to form a shaped article.

### EXAMPLES

### Creation of Articles

Test samples, or plaques, were constructed by injection molding a physical mixture of 50% masterbatch of TiO₂ in polyethylene along with virgin polypropylene resin (Flint Hills P4G4Z-011 polypropylene homopolymer, 12 MI, 0.9 g/cm3) in the ratios needed to reduce the 50% TiO₂ content down to the required concentration ranging from 5% to 20% TiO₂. The TiO₂ particles used consisted of 3.0 wt % SiO₂and 2.75 wt % Al₂O₃ based on core particle weight, and 0.2 wt % organic based on carbon value. The resultant mixtures were inserted into a Cincinnati Milacron Vista Toggle Injection Molder, containing a sample chip die. The injection molding machine produced sample plaques measuring 750 mm (L)×440 mm (W)×3.5mm (T), which had a smooth high gloss flat surface. These sample plaques were used to measure light reflectance spectra and to measure heat buildup when exposed to high intensity light.

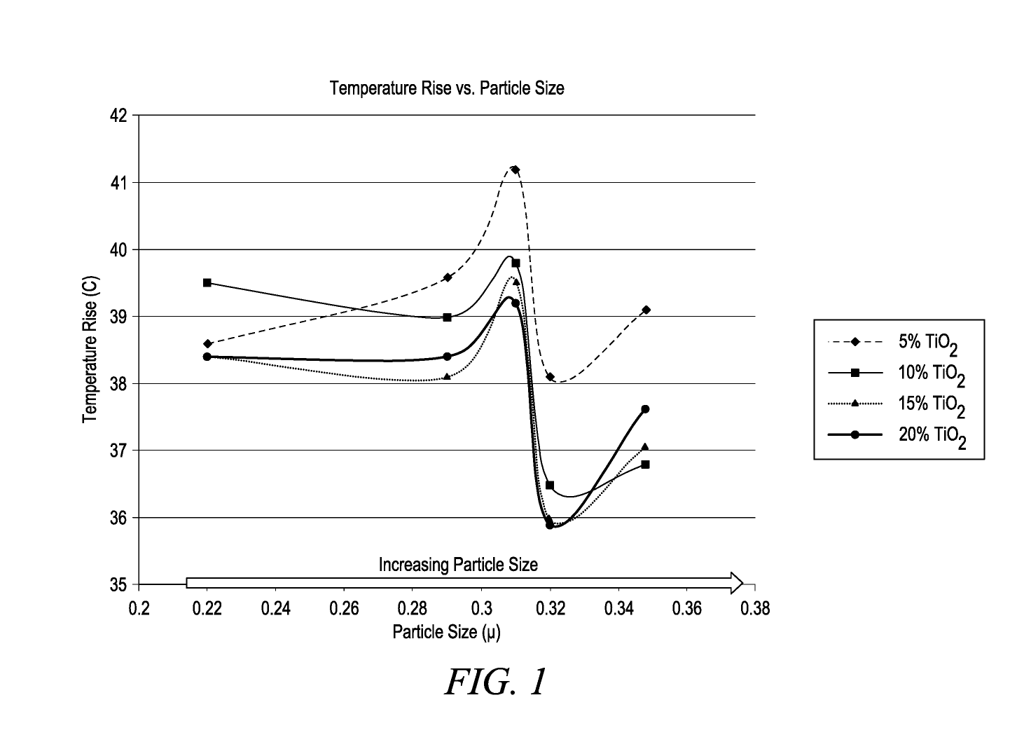

Samples observed in FIG. 1 were prepared by using five each of twenty different compositions that were constructed, comprising TiO₂ grades of five mean particle sizes at four combinations of weight percent TiO₂ (5, 10, 15, 20%). The value of each data point on the graph is the average of 5 readings taken at that combination of TiO₂ particle size and TiO₂ concentration.

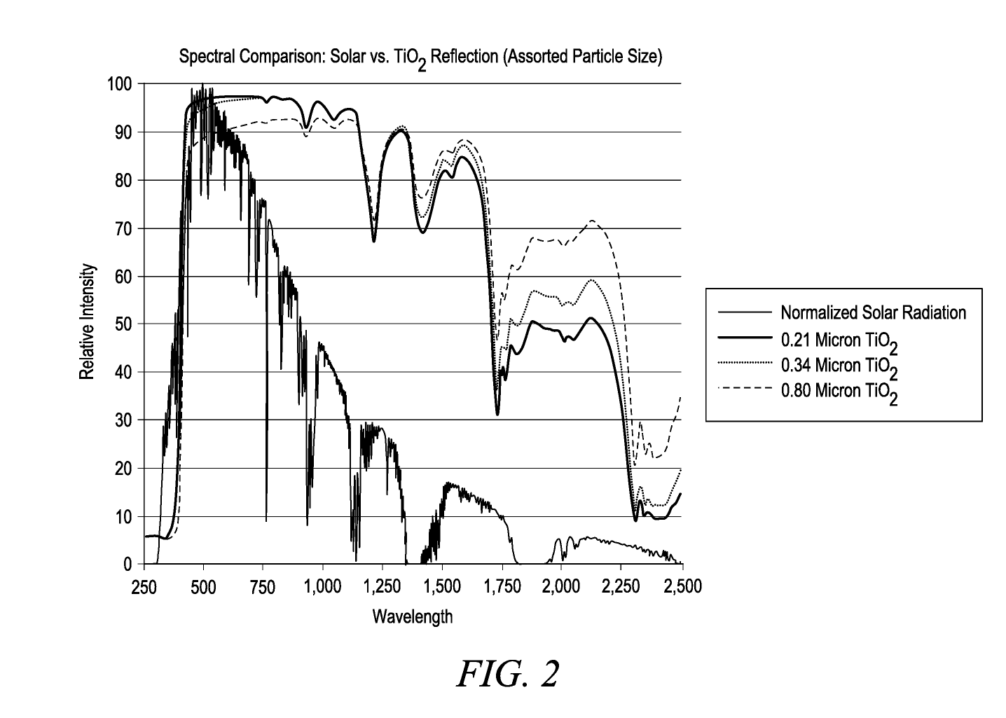

Samples observed in FIG. 2 were prepared with a sample plaque via injection molding and then measuring its reflection spectra utilizing a Varian (Agilent) Cary 5000 spectrophotometer equipped with a DRA-2500 diffuse reflectance accessory. The DRA-2500 uses a 150 mm integrating sphere. The reluctant spectra of each of the samples is plotted over the corresponding solar power spectra to observe the relative differences in reflectivity in the visible vs infrared portions of the spectra.

### Temperature Rise Test

As observed in FIG. 1, the FIG. 1 samples had undergone a temperature rise test per ASTM D4803, “Predicting Heat Buildup in PVC Building Products” incorporated herein by reference. A temperature rise test begins by placing a film under a light source for up to 1 hour. Distance between light source and film, equipment used 15.5 inches.

As illustrated in FIG. 1, when a sample uses a TiO2 particle size in the range of 0.31 and 0.34 there is a significant decrease in temperature rise. This means that the combination of reflection in the visible and the infrared regions is greater due to that particle size range than any other combination of wavelength reflections. This unique combination of reflected spectra is illustrated in FIG. 2.

### Spectral Comparison Test

As observed in FIG. 2, the samples have undergone a spectral comparison test that was performed by superimposing the total reflectance of each sample over the solar power spectra. As the particle size of the TiO₂ enlarges, the reflectance in the visible region of the spectrum (400-700 nanometers) decreases, while the reflectance in the infrared region (>700 nanometers) increases. FIG. 2 shows that the combination of decrease in visible reflectance and increase in infrared reflectance is most balanced for the 0.34 micron TiO2 particles. This balanced reflection maximizes the total reflection of the sample leading to a minimization of temperature rise in the sample as illustrated in FIG. 1.

What is claimed is:

1. Thermal resistant, low photo-activity, titanium dioxide particles comprising:
a) a TiO2 particle comprising a surface having a median particle size between 0.30 um and 0.38 um;
b) a silica coating;
c) an alumina coating having an interior and exterior surface; and
d) an organic coating,
wherein the silica coating is located between the surface of the TiO2 particle and the interior surface of the alumina coating and the organic coating is located on the exterior surface of the alumina coating.

2. The composition of claim 1 wherein the TiO2 particle further comprises a rutile crystalline form.

3. The composition of claim 1 wherein the organic coating is selected from the group of organic compounds selected from the group consisting of an organosiloxane, organosilane, alkyl carboxylic acid, alkyl sulfonate, organophosphate, orgaonophosphonate, and a combination thereof.

4. The composition of claim 3 wherein the organic coating is polydimethyl siloxane.

5. The composition of claim 1, wherein the median particle size is in the range of 0.32 and 0.36.

6. The composition of claim 1, wherein the median particle size is in the range of 0.32 um and 0.35 um.

7. The composition of claim 1 wherein the silica coating is in the range of 1.0 to 5.0 wt. % of the total particle weight.

8. A thermal resistant composition comprising:
a) a melt processible resin selected from the group consisting of a thermoplastic resin, a thermoset resin, or a combination thereof; and
b) one or more TiO2 particles comprising i) a surface and having median particle size between 0.30 and 0.38 μ;
ii) a silica coating; iii) an alumina coating having an interior and exterior surface; and d) an organic coating, wherein the silica coating is located between the surface of the TiO2 particle and the interior surface of the alumina coating and the organic coating is located on the exterior surface of the alumina coating.

9. The polymeric composition of claim 3 wherein the composition further comprises non-TiO2 inorganic fillers.

10. The thermal resistant composition of claim 8 in the form of an article.

11. The composition of claim 8 wherein the organic coating is selected from the group of organic compounds selected from the group consisting of an organosiloxane, organosilane, alkyl carboxylic acid, alkyl sulfonate, organophosphate, orgaonophosphonate, and a combination thereof.

12. The composition of claim 11 wherein the organic coating is polydimethyl siloxane.

13. The composition of claim 8, wherein the median particle size is in the range of 0.32 and 0.36.

14. The composition of claim 8, wherein the median particle size is in the range of 0.32 um and 0.35 um.

15. The composition of claim 1 wherein the silica coating is in the range of 1.0 to 5.0 wt. % of the total particle weight.
